(19) United States
(12) Patent Application Publication
(10) Pub. No.: US 2026/0109185 A1
(43) Pub. Date: Apr. 23, 2026

(54) TIRE VALVE

(71) Applicant: THE LEGION ENGINEERING CORPORATION, Changhua City (TW)

(72) Inventor: WAYNE-IAN MOORE, Worcestershire (GB)

(21) Appl. No.: 18/924,035

(22) Filed: Oct. 23, 2024

(51) Int. Cl. B60C 29/00; F16K 24/00

(52) U.S. Cl. CPC B60C 29/002; F16K 24/00

(57) ABSTRACT

A tire valve is provided, wherein the tire valve includes: a tubular member including an internal channel, a shoulder and a necked portion, the shoulder and the necked portion projecting radially inward in the internal channel; and a valve assembly resiliently squeezed through the necked portion and axially blocked by the necked portion to be disposed in the internal channel and restricted between the shoulder and the necked portion, and being operable to block or unblock the internal channel, wherein the valve assembly includes a valve pin, the valve pin includes an axial hole and at least one lateral hole in communication with the axial hole, and the at least one lateral hole is in communication with the internal channel.

### BACKGROUND OF THE INVENTION

### Field of the Invention

The present invention relates to a tire valve.

### Description of the Prior Art

A tire valve is installed on the rim and protrudes from the rim for inflation or deflation. Conventional tire valves mainly include a valve stem installed in a valve seat, a valve pin is disposed within the valve stem to control the passage or blockage of air, thereby maintaining a required tire pressure. In conventional tire valves, the valve pin usually requires threads to be screwed to a cap to prevent the valve pin from falling to the bottom of the valve stem and to ensure the valve's airtight function.

Conventional valve stems can be classified into two structural types. In one type, an outer threaded section is located at one end of the valve stem, configured to be screwed with the inner thread of the pump valve adapter. In the other type, at least one engaging slot is located at one end of the valve stem, configured for a detent member of the pump valve adapter to releasably engage therewithin. However, both of the two conventional valve stems are limited to use with inflation devices which should have a specific type of pump valve adapter. In other words, each of them can only work with an adapter that either have inner threads or at least one engaging slot, resulting in limited compatibility.

The present invention is, therefore, arisen to obviate or at least mitigate the above-mentioned disadvantages.

### SUMMARY OF THE INVENTION

The main object of the present invention is to provide a tire valve in which a valve pin can be easily and quickly installed and effectively blocked and restricted within the valve.

To achieve the above and other objects, a tire valve is provided, wherein the tire valve includes: a tubular member including an internal channel, a shoulder and a necked portion, the shoulder and the necked portion projecting radially inward in the internal channel; and a valve assembly resiliently squeezed through the necked portion and axially blocked by the necked portion to be disposed in the internal channel and restricted between the shoulder and the necked portion, and being operable to block or unblock the internal channel, wherein the valve assembly includes a valve pin, the valve pin includes an axial hole and at least one lateral hole in communication with the axial hole, and the at least one lateral hole is in communication with the internal channel.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is a cross-sectional view of an exemplary embodiment of the present invention.

FIGS. 4 and 5 are perspective views of a seat of an exemplary embodiment of the present invention;

FIGS. 6 and 7 are schematic diagrams showing a tire valve of an exemplary embodiment of the present invention assembled with different types of pump valve adapters;

FIG. 8 is a perspective view of another exemplary embodiment of the present invention.

FIG. 9 is an exploded view of the another exemplary embodiment of the present invention;

FIG. 10 is a schematic diagram showing a tire valve of the another exemplary embodiment of the present invention assembled with a pump valve adapter;

FIG. 11 is an exploded view of yet another exemplary embodiment of the present invention; and

FIG. 12 is a sectional view of the yet another exemplary embodiment of the present invention.

### DETAILED DESCRIPTION OF THE PREFERRED EMBODIMENTS

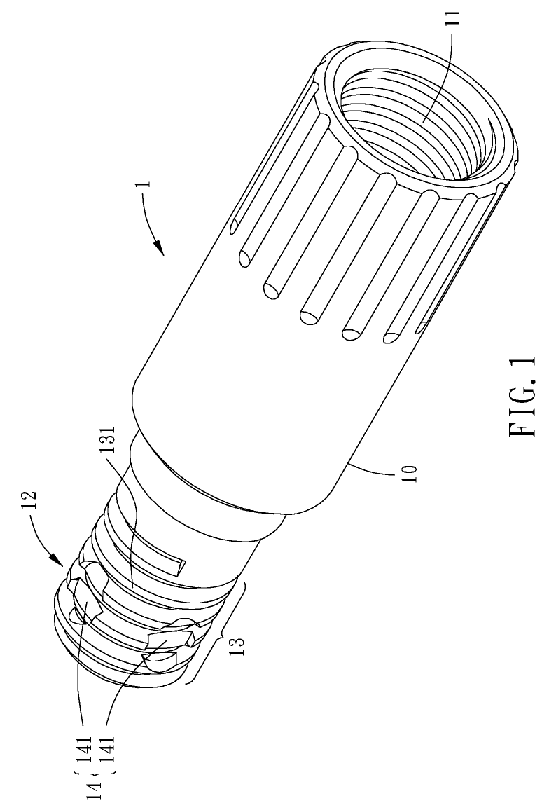

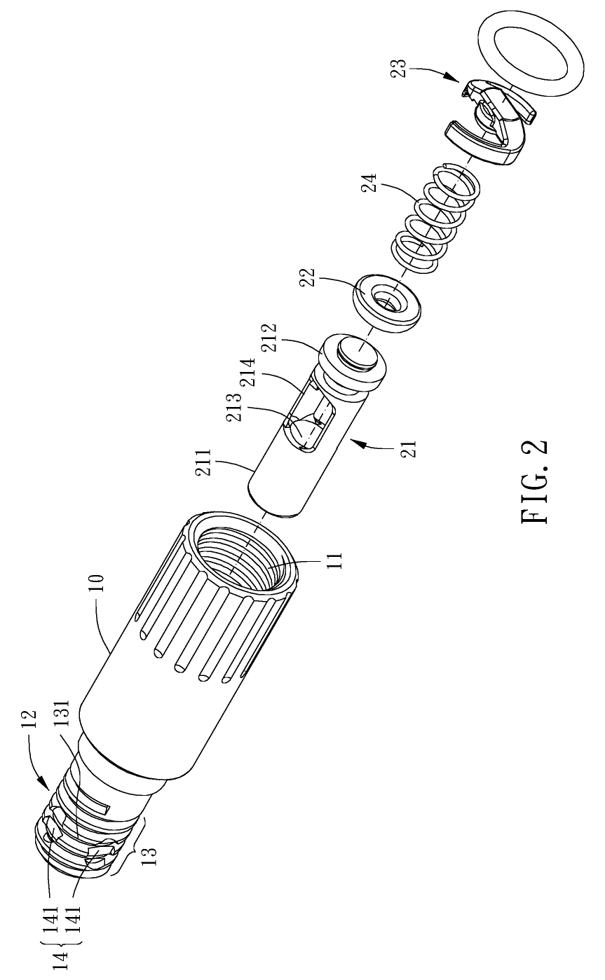

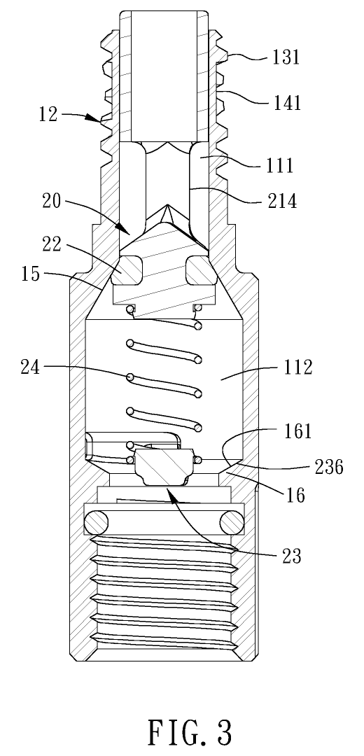

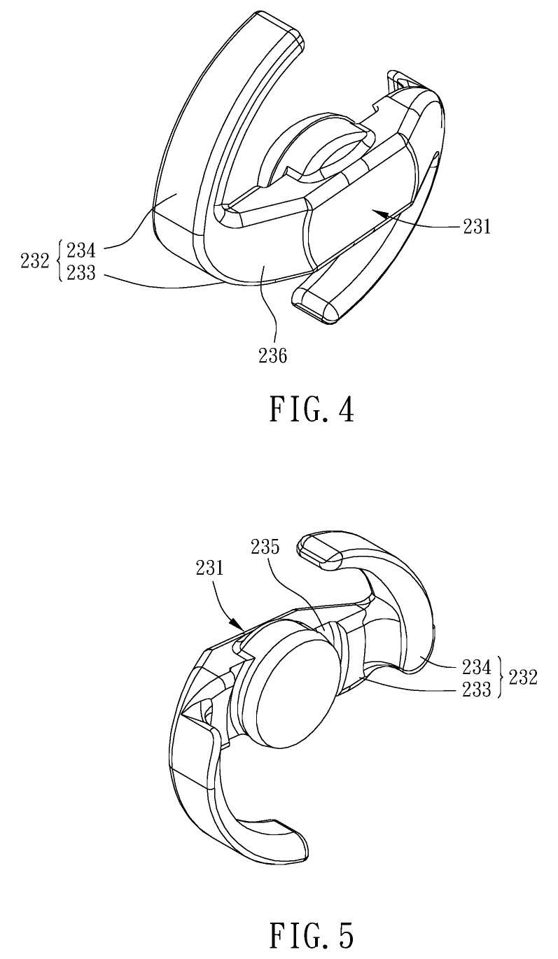

Please refer to FIGS. 1 to 7 for an exemplary embodiment of the present invention. A tire valve 1 of the present invention includes a tubular member 10 and a valve assembly 20. The tire valve 1 may be a Schrader valve, Presta valve, or English valve. The tubular member 10 may be integrally formed of one piece or a multi-piece assembly. For example, in a possible embodiment, the tubular member may include a valve body and a valve stem, the valve body and the valve stem may be integrally formed of one piece, wherein the valve body is configured to be connected to a rim, and the valve stem is connected to the valve body and extends outward beyond the rim.

The tubular member 10 includes an internal channel 11, a shoulder 15 and a necked portion 16. The shoulder 15 and the necked portion 16 project radially inward in the internal channel 11. The valve assembly 20 is resiliently squeezed through the necked portion 16 and axially blocked by the necked portion 16 to be disposed in the internal channel 11 and restricted between the shoulder 15 and the necked portion 16. The valve assembly 20 is operable to block or unblock the internal channel 11. The valve assembly 20 includes a valve pin 21, and the valve pin 21 includes an axial hole 213 and at least one lateral hole 214 in communication with the axial hole 213. The at least one lateral hole 214 is in communication with the internal channel 11. It is noted that the valve assembly structure of the present invention may be designed so that a portion of the valve pin (e.g., a shoulder) or a seal on the valve pin can engage with the shoulder. The seal on the valve pin may have a diametric dimension larger than an inner diametric dimension of the necked portion 16 such that the seal can be resiliently squeezed through the necked portion 16 and axially blocked by the necked portion 16 so that the valve pin can be restricted within the tubular member to prevent it from falling out. As such, the valve assembly 20 can be easily and quickly installed into the tubular member 10 and effectively blocked and restricted within the tubular member 10.

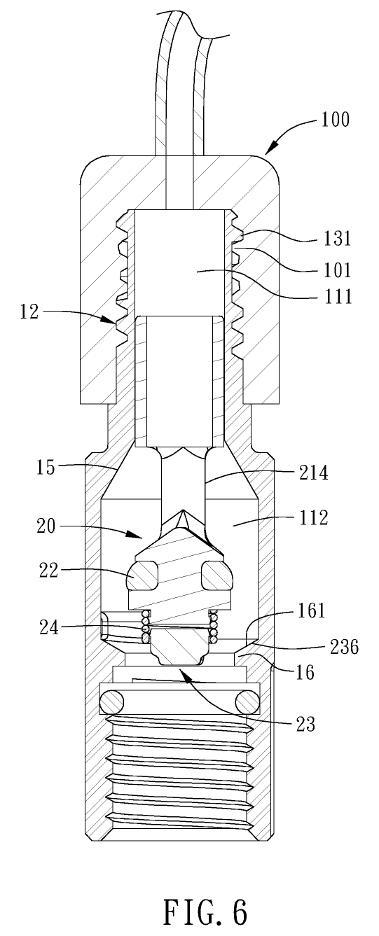

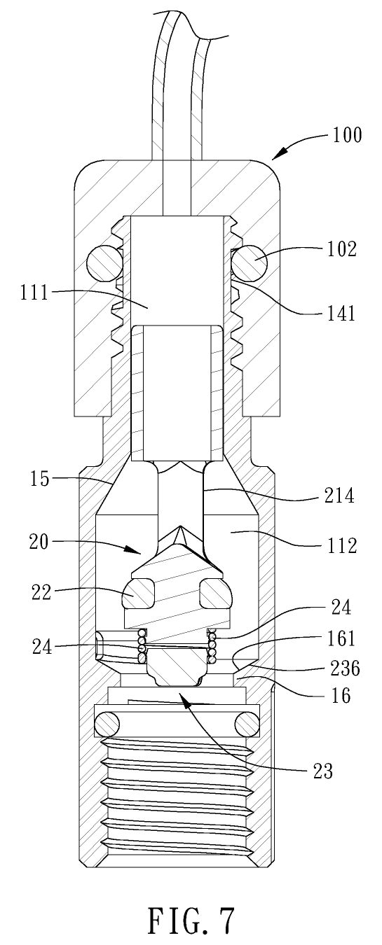

In this embodiment, the tubular member 10 further includes an insertion section 12, an outer threaded section 13 and at least one engaging slot 14. The insertion section 12 is defined as a portion of the tubular member 10 configured to be inserted into a pump valve adapter 100 of an inflation device. At least a part of the outer threaded section 13 and the at least one engaging slot 14 are disposed on the insertion section 12. The insertion section 12 is configured to be received within the pump valve adapter 100 of the inflation device. The outer threaded section 13 is configured to be releasably screwed with an inner thread 101 of the pump valve adapter 100 (FIG. 6), and the at least one engaging slot 14 is configured for at least one detent member 102 (e.g., a detent ball) of the pump valve adapter 100 to releasably engage therewithin (FIG. 7). As such, the tire valve 1 is compatible with different types of pump valve adapters, offering good adaptability without being limited to inflation devices with a specific type of valve adapter.

In this embodiment, the at least one engaging slot 14 is formed on the outer threaded section 13, and the at least one engaging slot 14 includes a plurality of concavities 141. The plurality of concavities 141 are circumferentially arranged at intervals on the outer surface of the tubular member 10, allowing the outer threaded section 13 to maintain good structural strength. However, the at least one engaging slot 14 may also include only a single concavity or be an annular groove; the received section 12 may further include a non-threaded section located on one side of the outer threaded section 13 (either closer to or farther from one side of an opening of the tubular member 10), and the at least one engaging slot 14 may also be located on the non-threaded section. The pump valve adapter 100 of the inflation device may be directly fitted onto the received section 12 without being screwed to the outer threaded section 13. The detent member 102 of the pump valve adapter 100 may be releasably engaged with at least one of the plurality of concavities 141, thereby stably connecting the pump valve adapter 100 and the tire valve 1 to perform inflation. When the pump valve adapter 100 of the inflation device is fitted onto the received section 12, the outer threaded section 13 may be entirely or partially located inside the pump valve adapter 100.

The outer threaded section 13 includes a plurality of threads 131, and the axial dimension of the at least one engaging slot 14 is greater than the width of one of the threads 131. For example, in this embodiment, each concavity 141 has an axial dimension greater than two times the width of the thread 131, providing a larger engagement area and achieving a good engagement effect.

Specifically, the internal channel 11 includes a first channel 111 and a second channel 112 located at opposite sides of the shoulder 15. The necked portion 16 is located in the second channel 112 and extends radially inward. The valve assembly 20 further includes a seal 22, a seat 23 and an elastic member 24. It is noted that the seat 23 may be omitted if the seal 22 on the valve pin 21 has a diametric dimension larger than an inner diametric dimension of the necked portion 16, wherein the seal 22 can be resiliently squeezed through the necked portion 16 and axially blocked by the necked portion 16 so that the valve pin can be restricted within the tubular member to prevent it from falling out. The valve pin 21 is disposed in the internal channel 11 and includes a tubular portion 211 and an end portion 212 connected to the tubular portion 211. The tubular portion 211 includes the axial hole 213 and the at least one lateral hole 214. One end of the axial hole 213 is open, and the tubular portion 211 is inserted into the first channel 111. The seal 22 is disposed on the valve pin 21 and located in the second channel 112. The seal 22 has an outer diametric dimension larger than a diametric dimension of the first channel 111. The seat 23 is resiliently squeezed through the necked portion 16 from the second channel 112 and is axially blocked by the necked portion 16. The elastic member 24 is abutted between the end portion 212 of the valve pin 21 and the seat 23, which can push the valve pin 21 so that the seal 22 releasably seals against the shoulder 15.

Specifically, the seat 23 further includes a base 231 and at least one arm 232. The at least one arm 232 is connected to the base 231 and is axially blocked by the necked portion 16. Each arm 232 includes a radial extension section 233 and a circumferential extension section 234. The radial extension section 233 is connected between the base 231 and the circumferential extension section 234. Preferably, the at least one arm 232 is an elastically recoverable structure. The at least one arm 232 is radially deformed to pass over the necked portion 16 and then radially expand to be blocked by one side of the necked portion 16, making installation simple and ensuring reliable blockage. In this embodiment, the seat 23 includes two arms 232 which are connected radially to opposite sides of the base 231. The circumferential extension sections 234 of the two arms 232 extend in opposite directions, which helps in inserting the seat 23 into the tubular member 10. However, the seat 23 may include more than two arms. The base 231 and the circumferential extension section 234 are axially protrusive beyond the same side of the radial extension section 233. The radial extension section 233 provides good support and structural strength, while the circumferential extension section 234 provides appropriate elastic deformability. The at least one arm 232 helps center the seat 23 and assists in stabilizing and securing the seat 23.

Specifically, the radial extension section 233 includes a recess 235. The recess 235 extends circumferentially along the base 231, and a portion of the elastic member 24 is disposed in the recess 235. The recess 235 facilitates the installation of the elastic member 24 and provides the seat 23 with good elastic deformation capability. The necked portion 16 includes an inclined abutment surface 161. Each arm 232 further includes an inclined abutment surface 236 which extends on the radial extension section 233 and the circumferential extension section 234. The inclined abutment surface 236 abuts against the inclined abutment surface 161, which makes the seat 23 more stable.

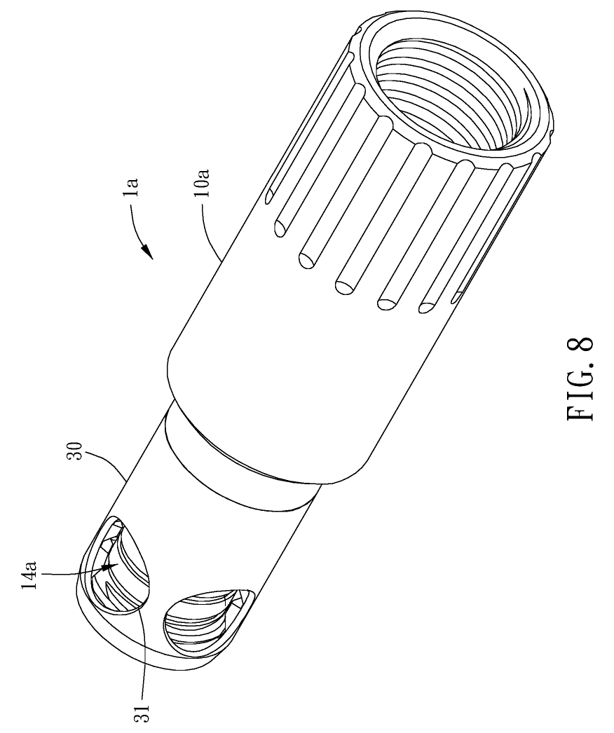

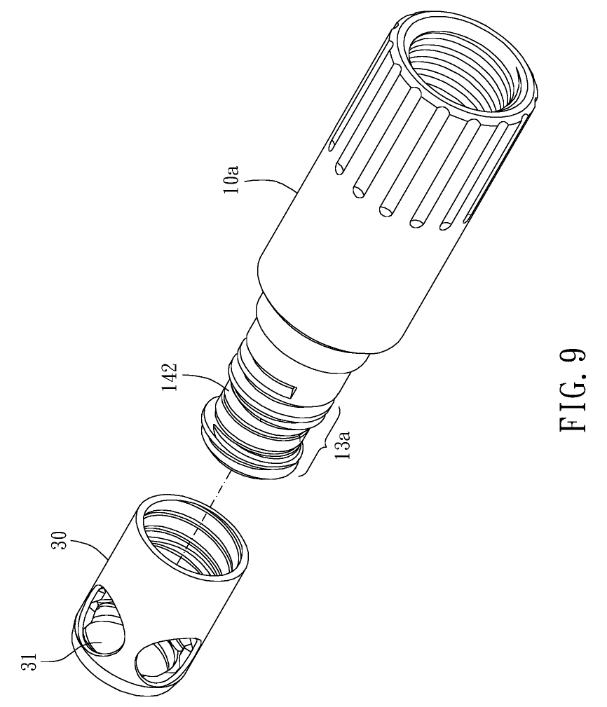

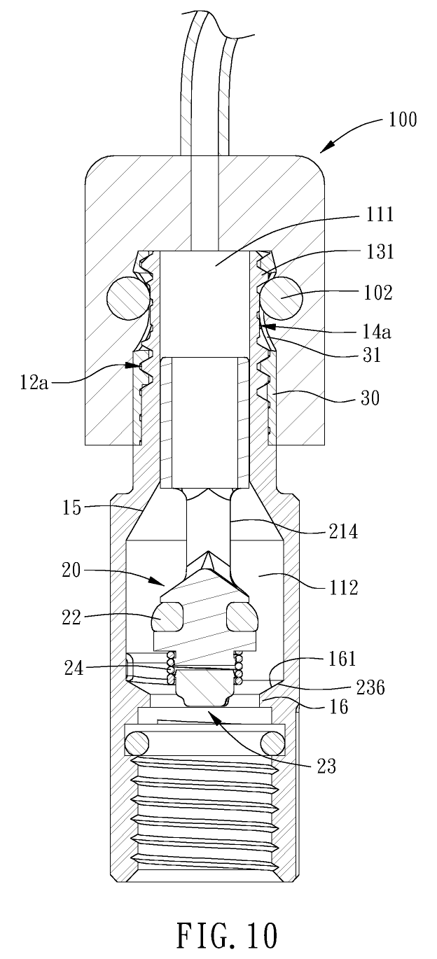

In an alternative embodiment, as shown in FIGS. 8 to 10, the at least one engaging slot 14a includes an annular groove 142 formed on the outer surface of the tubular member 10a. The tire valve 1a further includes a cage 30, wherein the cage 30 includes at least one through hole 31. The at least one through hole 31 corresponds radially to the at least one engaging slot 14a. The at least one through hole 31 is configured for the detent member 102 of the pump valve adapter 100 of an inflation device to be releasably engaged therewithin (FIG. 10). Preferably, the cage 30 includes a plurality of through holes 31, and the plurality of through holes 31 are equiangularly arranged, facilitating the alignment and engagement of the detent member 102 of the pump valve adapter 100. The cage 30 reinforces the structural strength of the outer threaded section 13. The pump valve adapter 100 of the inflation device may be directly fitted onto the insertion section 12a and the cage 30 without being screwed to the outer threaded section 13a. The detent member 102 of the pump valve adapter 100 may be releasably engaged within the at least one through hole 31 and the annular groove 142, thus stably connecting the pump valve adapter 100 and the tire valve 1 for inflation operations. However, in other embodiments, the cage 30 may not be screwed to the outer threaded section 13a, and the detent member 102 of the pump valve adapter 100 can still be releasably engaged in the annular groove 142.

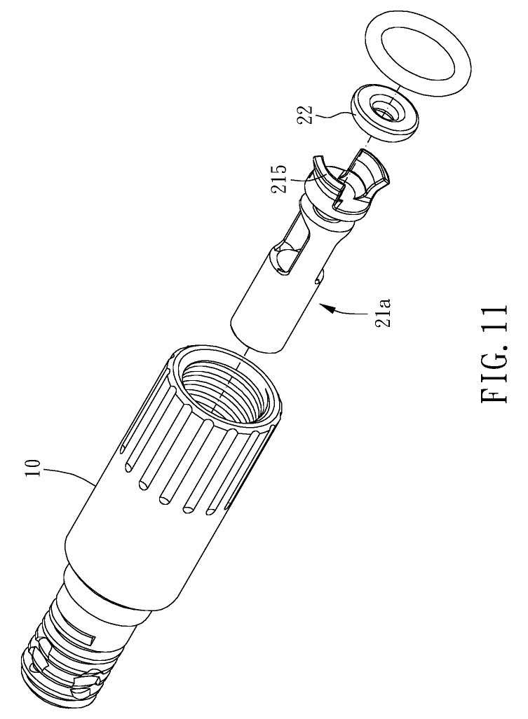

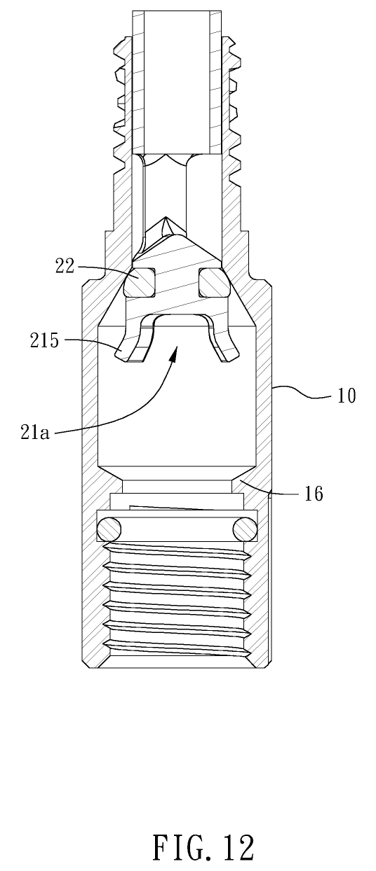

In another possible embodiment, as shown in FIGS. 11 and 12, the valve assembly may not include the aforementioned seat and elastic member. The valve pin 21a may include a plurality of legs 215 at one end, and the diametric dimension of the ends of the plurality of legs 215 is larger than the inner diameter of the necked portion 16. The plurality of legs 215 can deform radially to pass over the necked portion 16 and then radially expand to be axially blocked by one side of the necked portion 16, thereby restricting the valve pin 21a within the tubular member 10 to prevent it from falling out.

In other embodiments, the valve pin may be provided without any legs; the seal on the valve pin may have a diametric dimension larger than an inner diametric dimension of the necked portion such that the seal can be resiliently squeezed through the necked portion and axially blocked by the necked portion so that the valve pin can be restricted within the tubular member to prevent it from falling out; the valve pin may be urged upward by an elastic member; a portion of the valve pin (such as a shoulder located between the seal and the end opening of the valve pin) may be stopped by the shoulder of the tubular member; the seal may seals against the shoulder or seals against any part of an inner surface of the internal channel of the tubular member (such as an inner surface of the first channel) to block the internal channel.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tire valve including:
a tubular member including an internal channel, a shoulder and a necked portion, the shoulder and the necked portion projecting radially inward in the internal channel; and
a valve assembly resiliently squeezed through the necked portion and axially blocked by the necked portion to be disposed in the internal channel and restricted between the shoulder and the necked portion, and being operable to block or unblock the internal channel, wherein the valve assembly includes a valve pin, the valve pin includes an axial hole and at least one lateral hole in communication with the axial hole, and the at least one lateral hole is in communication with the internal channel.

2. The tire valve of claim 1, wherein the tubular member further includes an insertion section, an outer threaded section and at least one engaging slot, the insertion section is defined as a portion of the tubular member configured to be received within a pump valve adapter of an inflation device, at least a part of the outer threaded section and the at least one engaging slot are disposed on the insertion section, the insertion section is configured to be received within the pump valve adapter of the inflation device, the outer threaded section is configured to be releasably screwed with an inner thread of the pump valve adapter of the inflation device, and the at least one engaging slot is configured for at least one detent member of the pump valve adapter of the inflation device to releasably engage therewithin.

3. The tire valve of claim 2, wherein the at least one engaging slot is disposed on the outer threaded section.

4. The tire valve of claim 2, wherein the outer threaded section includes a plurality of threads, and the at least one engaging slot has an axial dimension greater than a width of one of the plurality of threads.

5. The tire valve of claim 2, further including a cage, wherein the cage includes at least one through hole, the at least one through hole the at least one engaging slot correspond to each other radially, and the at least one through hole is configured for the detent member of the pump valve adapter of the inflation device to releasably engage therewithin.

6. The tire valve of claim 2, wherein the internal channel includes a first channel and a second channel between which the shoulder is located, the necked portion is located in the second channel and extends radially inward, the valve assembly further includes a seal, a seat and an elastic member, the valve pin includes a tubular portion and an end portion connected to the tubular portion, the tubular portion includes the axial hole and the at least one lateral hole, one end of the axial hole is open, the tubular portion is inserted in the first channel, the seal is disposed on the valve pin and located in the second channel, the seal has an outer diametric dimension larger than a diametric dimension of the first channel, the seat is resiliently squeezed through the necked portion from the second channel and axially blocked by the necked portion, and the elastic member is abutted between the end portion of the valve pin and the seat to bias the valve pin so that the seal releasably seals against the shoulder.

7. The tire valve of claim 6, wherein the seat includes a base and at least one arm connected to the base, the at least one arm is an elastically recoverable structure, and the at least one arm is radially deformable to pass over the necked portion and then radially expands so that the seat is blocked by the necked portion.

8. The tire valve of claim 7, wherein each of the at least one arm includes a radial extension section and a circumferential extension section, and the radial extension section is connected to and between the base and the circumferential extension section.

9. The tire valve of claim 2, wherein the at least one engaging slot includes an annular groove formed on an outer surface of the tubular member.

10. The tire valve of claim 2, wherein the at least one engaging slot includes a plurality of concavities, and the plurality of concavities are circumferentially arranged in intervals on an outer surface of the tubular member.
